(19) United States
(12) Patent Application Publication
(10) Pub. No.: US 2006/0111825 A1
(43) Pub. Date: May 25, 2006

(54) Vehicle network system and component of network

(75) Inventors: Minoru Okada, Gifu-city (JP); Hirotaka Sakai, Handa-city (JP); Takayuki Toya, Kariya-city (JP); Yosuke Hattori, Ama-gun (JP); Masashi Kato, Nagoya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/282,068

(22) Filed: Nov. 17, 2005

(30) Foreign Application Priority Data
Nov. 19, 2004 (JP) 2004-335922

(51) Int. Cl. B60R 22/00

(52) U.S. Cl. 701/48; 701/1; 701/36

(57) ABSTRACT

An electronic control unit (ECU) having multiple layers of distributed network control functionality is used to facilitate development of complicated vehicle control network system. That is, for example, three layers of distributed network control functionality are devised in the ECU. The three layers of functionality include a so-called application layer that provides a structurally functional framework of function reusability, extensibility and independence as well as an interface (I/F) for functional context, a so-called system infrastructure layer that uniformly manages system resources for an entire system development scheme based on a rule, and a so-called hardware abstraction layer that controls hardware system as an abstractive object including electrical property of devices such as ECUs, sensors and/or actuators as well as a network itself.

### CROSS REFERENCE TO RELATED APPLICATION

This application is based on and claims the benefit of priority of Japanese Patent Application No. 2004-335922 filed on Nov. 19, 2004, the disclosure of which is incorporated herein by reference.

### FIELD OF THE INVENTION

The present invention generally relates to a vehicle network for connecting an electric control unit.

### BACKGROUND OF THE INVENTION

In recent years, various types of data are exchanged in a vehicle through a vehicle network for controlling the vehicle. That is, the data is exchanged between electric control units (ECUs) for controlling various types of devices. The vehicle network connects those ECUs by communication bus to accommodate various types of communication, and appropriately facilitates cooperation of ECUs for seamlessly controlling the vehicle.

Development of those ECUs connected to the vehicle network is necessarily accompanied by the development of software that is used for providing an interface for the ECUs to the vehicle network in terms of handling a complicated specification for controlling control application (application program) and for controlling communication process (communication program).

However, the ECUs used in the vehicle come in various types, and further the ECUs are provided by different sections in various companies. Therefore, the interfaces of those ECUs are respectively focused to accommodate functional control of the individual ECU. That is, the specification of the interface of the individual ECU is respectively different and/or complicated in a different manner. Further, the same type of process is redundantly implemented in many functional units, thereby increasing the development scale of the software.

In addition, the interfaces of those ECUs designed in a respectively different manner for each functional unit lead to numerous variations in terms of vehicle types and/or intended destinations. This scheme of development further complicates the process of system development, and causes problems such as deteriorated product quality and the like.

Based on the situation described above, an ECU for the vehicle network by using a quality software that can be developed with ease is proposed in Japanese Patent Document JP-A-2002-204238.

The disclosed ECU exchanges data frames on the network, and recognizes necessary data in those frames for simplicity of data processing in a communication program commonly used by the variations of the ECU.

The communication program commonly used in different types of ECUs eliminates an effort and trouble for the development of different communication programs, and thus leads to a decreased development scale and/or simplified process of network system development.

However, the ECU disclosed in the above document simply provides a function for encapsulating the communication process. That is, the ECU having this feature has to have a software tool for reduction of development terms and/or variation handling when the ECU is used in a large scale development.

Further, the ECU having this feature has to have a quality assurance software for tracing a functional error in the system because of a complication of the software structure when the ECU is used in the large scale development.

### SUMMARY OF THE INVENTION

In view of the above-described and other problems, the present invention provides a vehicle network system and an electronic control unit that achieve a reduced development time for a large scale development.

The present invention also provides the vehicle network system and the electronic control unit that achieve the reduced development time even in the course of accommodating many variations of different vehicle types.

The present invention also provides the vehicle network system and the electronic control unit that maintain quality and reliability even when the vehicle network system is developed in a large scale.

In the course of devising a method of the present invention, the inventor analyzed the requirement for effectively achieving the goal of the invention. The analysis yielded the conclusion that the ease of a large scale development of a vehicle network system comes from a clear-cut division of development roles by using a software tools, a reduction of complicated dependence between software components, and extensibility of the software components. That is, these characteristics are keys for reduction of the development time, assurance of the software quality, and accommodation of enormous variations.

The analysis of the requirements leads to a conclusion that the interfaces between the higher systems should be built upon the interfaces between individual functional units, independence of the interfaces from an intended function and standardization of the observable quantity.

Further, quality control based on the availability of the functions and information on correctness as well as the observable quantity can be used to facilitate trouble shooting based on an identification of a troubled portion.

The inventors of the present invention implemented the above described characteristics as a distributed control platform in a layered basic structure of a vehicle network system.

Based on the analysis described above, the vehicle network system of the present invention includes a functional framework for providing a control logic that is given by external definition, a system coordinator for issuing a control request base on a capacity and a status of control functionality as well as determining an execution order and/or schedule of the control functionality, a system structure controller for dynamically maintaining and reorganizing control functionality of the electronic control unit based on the definition of the control functionality, a virtual sensor for detecting and outputting observable quantity as a sensor signal, and a hardware abstraction portion for abstractively representing an entire hardware system including the electronic control unit as a virtual electronic control unit for the system structure controller and the virtual sensor.

The vehicle network system of the present invention can implement an intended function only by providing the control logic to the functional framework. Commonality of a portion of the electronic control unit other than the control logic portion makes it possible to have a clear-cut division of development roles for facilitating division and cooperation of development. The division and cooperation of the development leads to a reduction of development time, assurance quality of the developed system and variation management in a restriction of the development time.

According to one aspect of the present invention, the vehicle network system described above can be, for example, implemented in three layers of components, that is, an application layer having the functional framework and a system infrastructure layer having the system structure controller, the virtual sensor and the system coordinator, and a hardware abstraction layer having the system abstraction layer in addition to an electronic control unit abstraction layer and a communication abstraction layer

According to yet another aspect of the present invention, the functional framework having a hierarchical functional structure includes a coordinator for outputting an order/request signal, and a functional component for implementing a predetermined function and outputting an availability signal that is an indicator for a state of functional component and a capability of functionality as well as an availability of the predetermined function. The coordinator outputs the order/request signal based on the availability signal and the sensor signal from the virtual sensor, and the functional component outputs the availability signal based on the sensor signal from the virtual sensor.

According to the structure described above, the functional framework can be implemented throughout the system, i.e., from an upstream toward -branches in a downstream of the system, for controlling the order/request signal, the availability signal and the sensor signal.

The order/request signal represent an amount of control instruction/an amount of control requirement, and the availability signal represent the state of functional component and the capability of functionality. These quantities are used as a framework of the development of the control function. Further, the sensor signal that represents the observable quantity is calculated by using a platform software separately from a control algorithm to be provided for the development of control.

According to still yet another aspect of the present invention, the hardware abstraction portion informs the system structure controller of the state of the hardware system including a plurality of the electronic control units, and the system structure controller appropriately reorganizes the control functionality based on the state of the hardware.

In this manner, the system structure controller determines the functional structure of the system by selecting an optimal function among available functions based on the state of hardware.

According to still yet another aspect of the present invention, the virtual sensor handles and controls physical value derived from an actual sensor included in the hardware system and the observable quantity that is abstracted from the physical value as system data. For example, the virtual sensor can calculate a observable quantity based on the physical value detected by the actual sensor as a clue of a physical phenomenon.

In this manner, the virtual sensor takes the physical data as well as the calculated observable quantity as the system data for virtually compensating a lack of a sensor for required data.

According to still yet another aspect of the present invention, the system coordinator implements the predetermined function in each layers of the hierarchical control functionality as the coordinator for outputting the order/request signal and the execution schedule and the functional component for implementing the predetermined function and outputting the availability signal that is the indicator for the state of functional component and the capability of functionality as well as the availability of the predetermined function. Further, the coordinator outputs the order/request signal and the execution schedule based on the availability signal and the sensor signal from the virtual sensor. Furthermore, the functional component outputs the availability signal based on the sensor signal from the virtual sensor and implements the predetermined function based on the execution schedule.

In this manner, the functional framework can be implemented throughout the system from an upstream toward branches in a downstream of the system, for controlling the order/request signal, the availability signal and the sensor signal.

The order/request signal represent an amount of control instruction/an amount of control requirement, and the availability signal represent the state of functional component and the capability of functionality. These quantities are used as a framework of the development of the control function. Further, the sensor signal that represents the observable quantity is calculated by using a platform software separately from a control algorithm to be provided for the development of control.

According to still yet another aspect of the present invention, a trouble in the hardware system is recorded in the availability signal as trouble data for a trace of the trouble.

According to still yet another aspect of the present invention, a tester on the communication bus is used to indicate a troubled component based on the availability signal that includes the trouble data.

According to still yet another aspect of the present invention, the system coordinator organizes/coordinates the coordinators to autonomously covers/compensates a trouble of any of the coordinators in a layer by using other coordinator for outputting the execution schedule of the functional components in the same layer.

In this manner, a trouble in the system can autonomously be covered by other portion of the system for continuous operation.

According to still yet another aspect of the present invention, the vehicle network system having the above-described features can also be perceived as an implementation of the electronic control unit in the vehicle network system.

### BRIEF DESCRIPTION OF THE DRAWINGS

Other objects, features and advantages of the present invention will become more apparent from the following detailed description made with reference to the accompanying drawings, in which:

FIG. 1 shows a block diagram of a vehicle network in a first embodiment of the present invention;

FIG. 2 shows a block diagram of an electric control unit in the vehicle network in FIG. 1;

FIG. 3 shows an illustration of functional components in the vehicle network in FIG. 1;

FIG. 4 shows a block diagram of component structure in a domain;

FIG. 5 shows an illustration of observable quantity as data exchanged among electrical control units;

FIG. 6 shows an illustration of sensor signal communication from a virtual sensor to a system coordinator;

FIG. 7 shows a block diagram of functions in the system coordinator;

FIG. 8 shows a block diagram of relationships of components in the domain;

FIG. 9 shows a block diagram of trouble tracking in the vehicle network;

FIG. 10A shows an illustration of functional distribution in a normal status;

FIG. 10B shows an illustration of functional distribution in a trouble status;

FIG. 11A shows an illustration of execution scheduling in a normal status;

FIG. 11B shows an illustration of execution scheduling in a trouble status;

FIG. 12 shows a block diagram of a relationship between the system coordinator and a system structure management function;

FIG. 13 shows a block diagram of the vehicle network having a system arbitration function; and

FIG. 14 shows a block diagram of the vehicle network having a subsystem arbitration function in each layer.

### DETAILED DESCRIPTION OF THE PREFERRED EMBODIMENTS

An embodiment of the present invention is described with reference to the drawings.

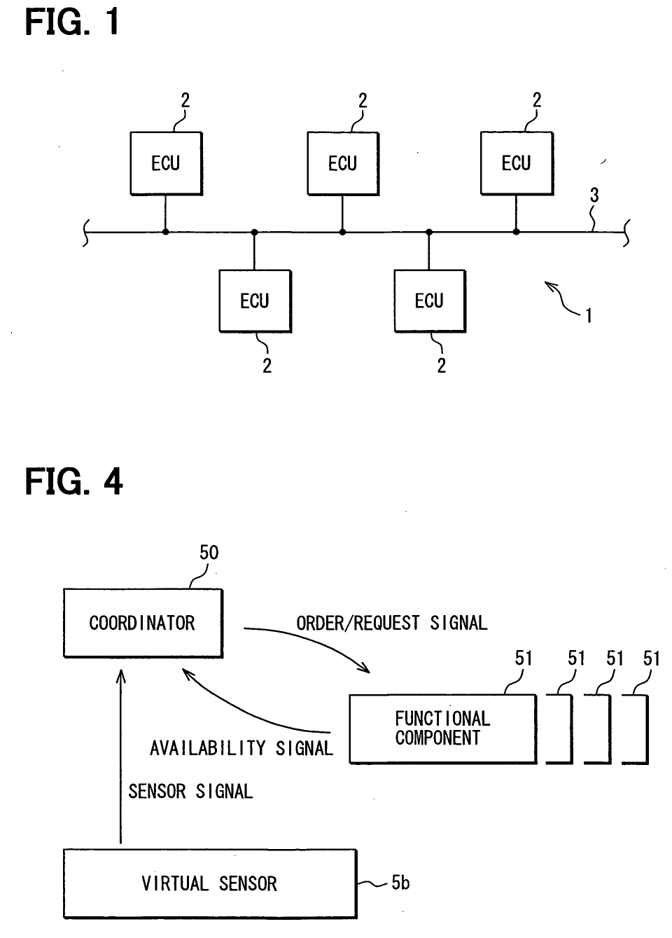

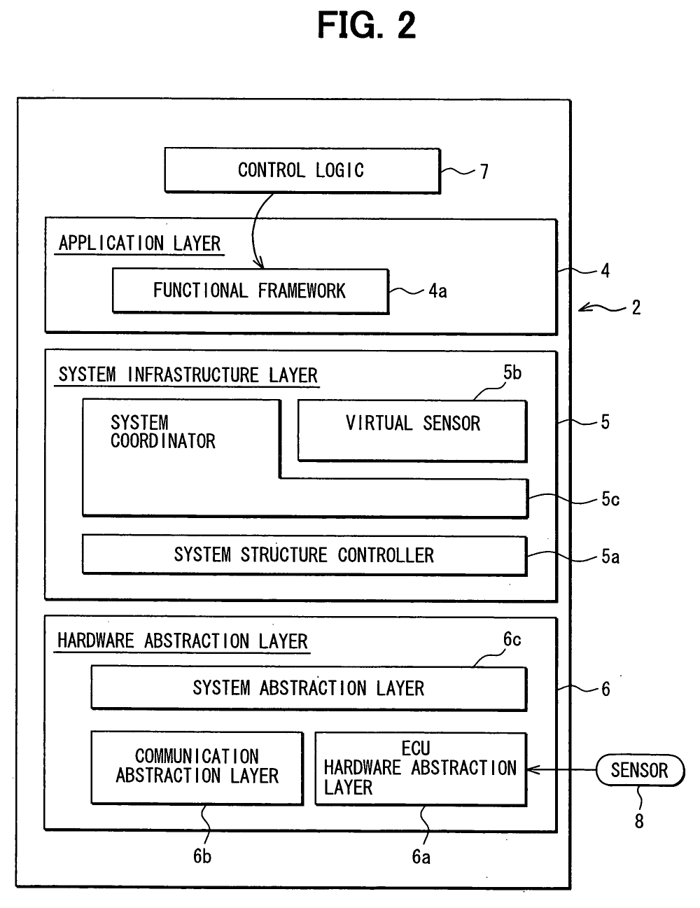

FIG. 1 shows a block diagram of a vehicle network 1 in an embodiment of the present invention. FIG. 2 shows a block diagram of an electronic control unit in the vehicle network in FIG. 1.

As shown in FIG. 1, the vehicle network includes a plurality of the electronic control units (ECUs) 2 such as, for example, an engine ECU, a brake ECU a steering ECU and the like, and a communication bus 3 that connects those ECUs 2. Each of the ECUs 2 implements its functionality by executing calculation and control operation according to a application program stored therein.

As shown in FIG. 2, each of the ECU 2 has a basic structure that includes three layers of components, that is, an application layer 4, a system infrastructure layer 5 and a hardware abstraction layer 6.

The application layer 4 provides a structural framework for a functional component having reusability of a function, extensibility and independence. The application layer 4 also provides an interface for various functions. The system infrastructure layer 5 provides a function for monopolistically managing system resources that are used by an entire system development scheme based on rules of management. The hardware abstraction layer 6 provides an abstracted representation of an entire hardware system that includes the vehicle network 1 as well as the ECU 2, sensors and actuators together with their electrical characteristics.

The three layers mentioned above will be described in detail in the following sections.

The application layer 4 includes functional frameworks 4a for providing actual functions and interfaces as frameworks of functional control defined in a system. A control logic 7 implemented in the functional framework 4a will realize an actually working system.

The functional framework 4a is changed when different functional structure is implemented in the system.

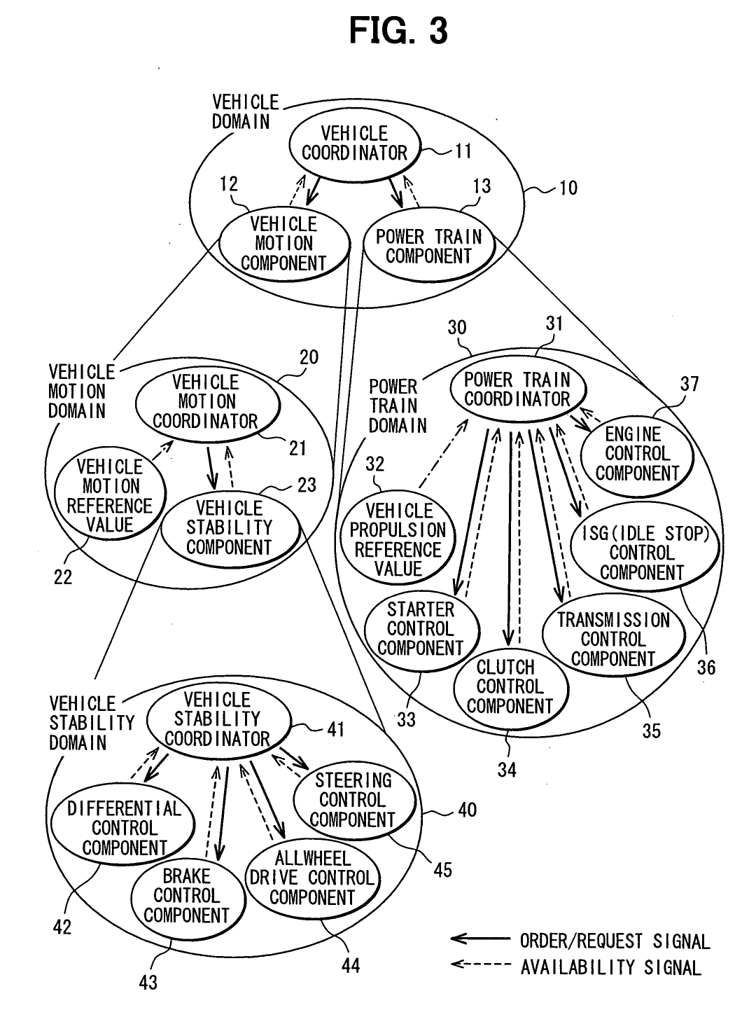

FIG. 3 shows an illustration of functional components in the vehicle network 1 in FIG. 1. The vehicle network 1 in this example includes a vehicle coordinator 11 at a top level, and this vehicle coordinator 11 manages a vehicle motion component 12, a power train component 13 and the like. The vehicle coordinator 11 belongs to and manages a layer of a vehicle domain 10.

The vehicle motion component 12 further includes a vehicle behavior coordinator 21 for stabilizing a vehicle by using a vehicle stability component 23 based on a vehicle motion reference value 22 such as a wheel speed, a yaw rate, vertical/horizontal accelerations and the like. The power train component 13 further includes a power train coordinator 31 and functional components such as a starter control component 33, a clutch control component 34, a transmission control component 35, an engine control component 36, and an ISG (idle stop) control component 37 for controlling a vehicle propulsion force based on a vehicle propulsion reference value 32. The vehicle behavior coordinator 21 and the power train coordinator 31 belongs to and manages a layer of a vehicle behavior domain 20 and a power train domain 30.

The vehicle stability component 23 further includes a vehicle stability coordinator 41 and other components such as a differential control component 42, a brake control component 43, an all wheel drive control component 44 and a steering control component 45 for stabilizing a vehicle. The starter control component 33, a clutch control component 34, a transmission control component 35, an engine control component 36, and an ISG (idle stop) control component 37 further include coordinators in a lower level for controlling respective functionality (not shown in the figure). The vehicle stability coordinator 41 manages a layer of a vehicle stability domain 40. In this manner, the functional framework 4a includes a hierarchy of functions from a top level to subsequent levels as components in the power train domain 30 and the vehicle stability domain 40 further include sub-domains.

FIG. 4 shows a block diagram of component structure in those domains. That is, each domain basically includes a coordinator 50 and a component 51 in a subsequent level, and the coordinator 50 and the component 51 receive a sensor signal from a virtual sensor 5n. Each component 51 controls an order/request signal, an availability signal and the sensor signal in this basic structure for the purpose of tracking a trouble. The troubled portion of the system can be identified by analyzing the signal that carries a clue of the trouble.

The order/request signal is an interface to a control instruction amount and a control request amount exchanged between the component in the subsequent level. The availability signal is an interface to a capability and/or a state of the component 51 in the subsequent level, that is, information on a capability of functionality and a state of functional component. The availability signal is described in detail in the following section. The sensor signal is an interface to an observable quantity in the virtual sensor 5b as described later in detail.

The coordinator 50 determines a process demand amount exchanged between the components 51 in the subsequent level based on the sensor signal and the availability signal, and outputs the amount as the order/request signal. The order/request signal received by the component 51 triggers control operation for handling the process demand amount in the signal. The state and the expected control operation (capability) of the component 51 are transferred to the coordinator 50 as the availability signal. The vehicle status changed by this control operation is detected and stored in the virtual sensor 5b, and the detected change is sent to the coordinator as the sensor signal of feedback.

In this manner, the domains comprising various components have a hierarchical structure. The signal from each level of the hierarch can be distinguishably recognized. The subsequent level of the functional component may have further subsequent level, and not limited to one level as shown in FIG. 4.

The system infrastructure layer 5 includes a system structure controller 5a, a virtual sensor 5b and a system coordinator 5c.

The system structure controller 5a is a function that determines an optimal functional structure based on the state of the vehicle network 1 and the electronic control units 2 being provided from the hardware abstraction layer 6. The system structure controller 5a stores information on the function of each of the ECUs 2 and informs the system coordinator 5c of the available ECUs 2 extracted from the entire ECUs 2.

For example, functional error and/or boot process timing of the vehicle network 1 and the ECUs 2 as well as an addition of options may result in a different configuration the hardware state and thereby causing change in the vehicle control function in the system of the vehicle network 1. The system structure controller determines the functional structure based on an operation state of the ECUs 2 in order to prevent the malfunction of the vehicle control function.

Further, the vehicle network 1 has to be carefully examined when the ECUs 2 on the vehicle network 1 are switched to a sleep condition. That is, each of the ECUs 2 on the vehicle network 1 has to be checked that it is not involved in a distributed operation scheme of a currently working function before being put in the sleep mode upon turning off an ignition key.

In view of the above-described situation, the system structure controller 5a determines the ECUs 2 and the like that are put in the sleep mode. Wake up operation of the ECUs 2 is determined and executed in the same manner. In this manner, the system structure controller 5a controls the logical function of the system and maintains integrity of the hardware (ECUs 2).

The virtual sensor 5b takes control of physical data derived from a sensor 8 and received by the ECU 2 as well as the calculated observable quantity as system data for virtually compensating a lack of the sensor 8 for required data.

The virtual sensor 5b calculates the observable quantity that takes physically controlled object into account instead of outputting sensor signals from individual functional unit to the control logic 7. In this manner, the observable quantity can be standardized and shared by the entire vehicle network 1.

For example, the virtual sensor 5b detects a wheel speed, an acceleration, a yaw rate, a steering angle and the like. The virtual sensor 5b also yields a tire load of a tire that cannot be detected directly by the sensor 8. The virtual sensor 5b provides those data to feedback control of a control application and system coordinator 5c. The data from the virtual sensor 5b is also sent to the functional components.

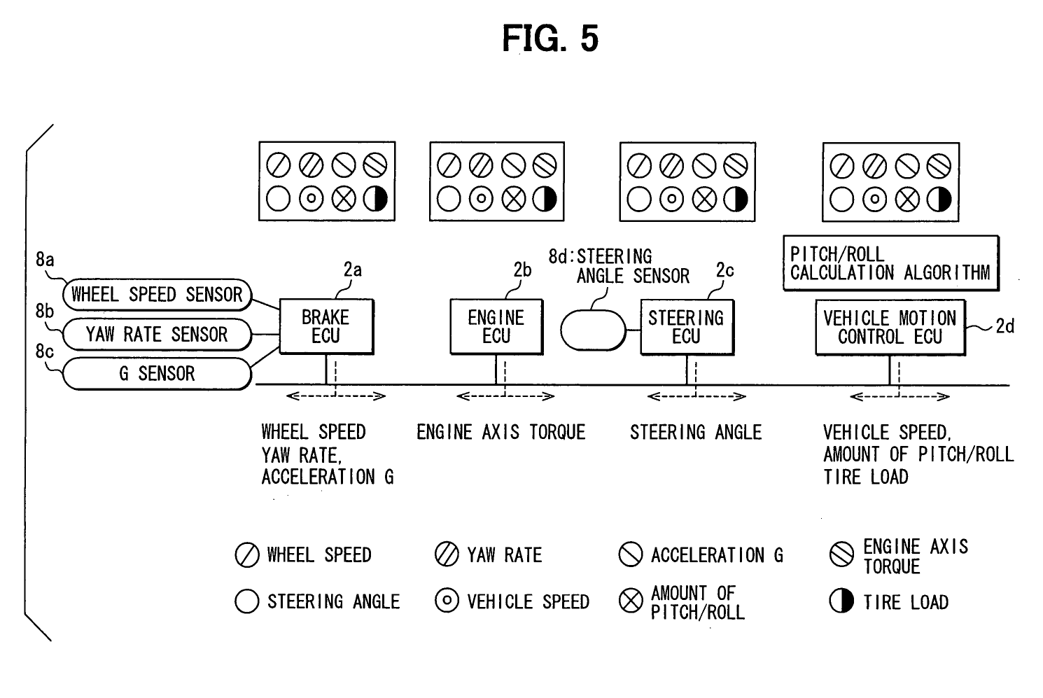

FIG. 5 shows an illustration of observable quantity as data exchanged among the ECUs 2. The figures in the rectangles arranged above in FIG. 5 show content of data stored in each of the ECUs 2.

The vehicle network 1 includes a brake ECU 2a, an engine ECU 2b, a steering ECU 2c, a vehicle motion ECU 2d as the ECUs 2. In this case, the brake ECU 2a receives detection signals from a wheel speed sensor 8a, a yaw rate sensor 8b, and an acceleration (G) sensor 8c for calculation of a wheel speed, a yaw rate, and an acceleration. The engine ECU 2b calculates an engine axis torque. The steering ECU 2c calculates a steering angle based on a detection signal from a steering angle sensor 8d. The vehicle motion ECU 2d calculates a vehicle speed, a pitch, a roll, a tire load and the like based on the physical value calculated in the ECUs 2a to 2c.

The physical values calculated in each of the ECUs 2a to 2c are interchangeably transferred through the communication bus 3 to other ECUs 2. In this manner, the physical values are shared by all ECUs 2.

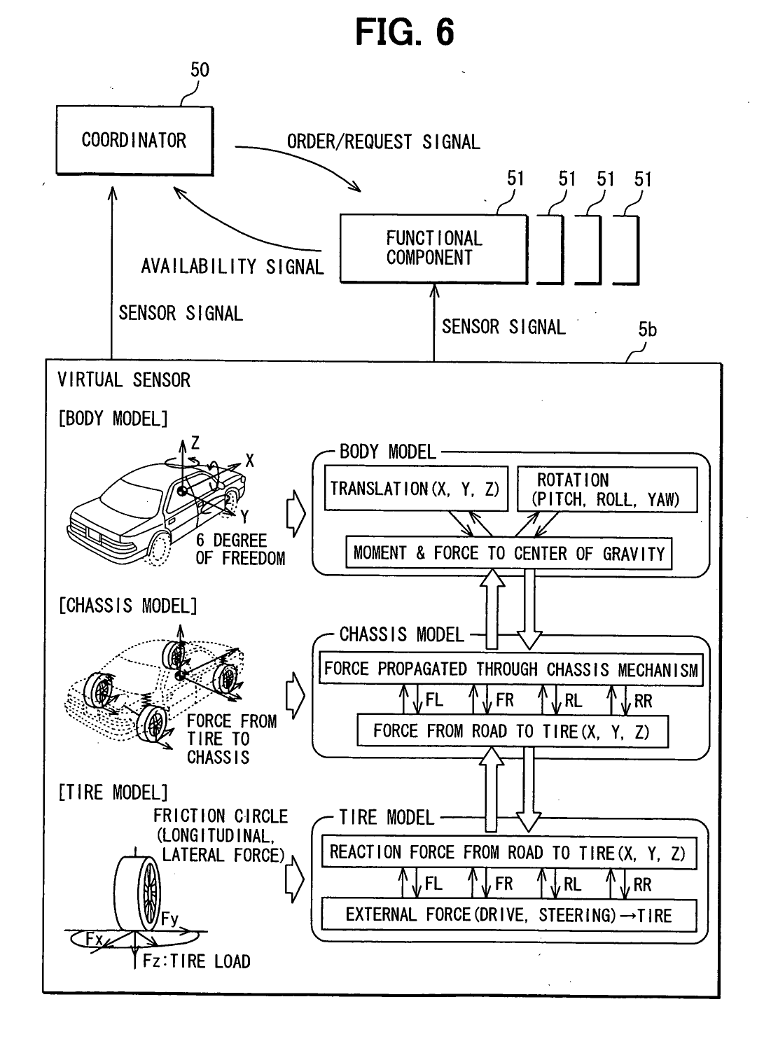

The physical value may include an environmental condition of the vehicle. FIG. 6 shows an illustration of sensor signal communication from the virtual sensor 5b to a system coordinator 5c. For example, the virtual sensor 5b detects external force such as a driving force, a braking force, and a steering force for each of the wheels, and action/reaction forces between a road and the tire in each of the X, Y and Z direction are calculated based on a chassis model (model of mechanism under chassis, i.e., a suspension, a tire, a wheel). The reaction forces are used for calculation of translation motion and rotation motion (pitch/roll/yaw) of a body. The moment around the center of gravity of the vehicle can then be calculated.

The observable quantity is calculated with a reliability index. The reliability in this case includes a static range of the observable quantity, and a dynamic characteristics in a response to a command, an accuracy in terms of time factor (elapsed time after update), and a combination of the observable quantity.

Further, failure of a specific sensor and/or lack of the sensor can be covered by the observable quantity derived from other sensors. For example, the failure of the sensor can be managed by calculating the estimated observable quantity instead of explicitly changing the type of the observable quantity. In this manner, the same algorithm can handle both of the normal and abnormal situations.

The observable quantity can further be abstractive by combining two or more observable quantityes and/or by calculating one more higher hierarchy of the observable quantity.

The system coordinator 5c outputs control request according to the components included in the functional structure determined by the system structure controller 5a, and determines an execution order and schedule of each function in the component. That is, the system coordinator 5c has a function distribution feature and a execution scheduling feature.

The system coordinator 5c has a structure of function distribution as a platform and thereby enables same functional logic to be applied both to a normal operation and an abnormal operation. In this manner, a system for operating the vehicle in optimal performance according to a vehicle condition can be constructed. That is, the system coordinator 5c realizes the fail-safe system structure as a built-in characteristic.

Further, the system coordinator 5c arranges the execution scheduling by using functional units as well as software component units. That is, the developer can design the system flow and response as early as the beginning of the design phase. In other words, the system coordinator 5c schedules the execution of the system from a designers point of view.

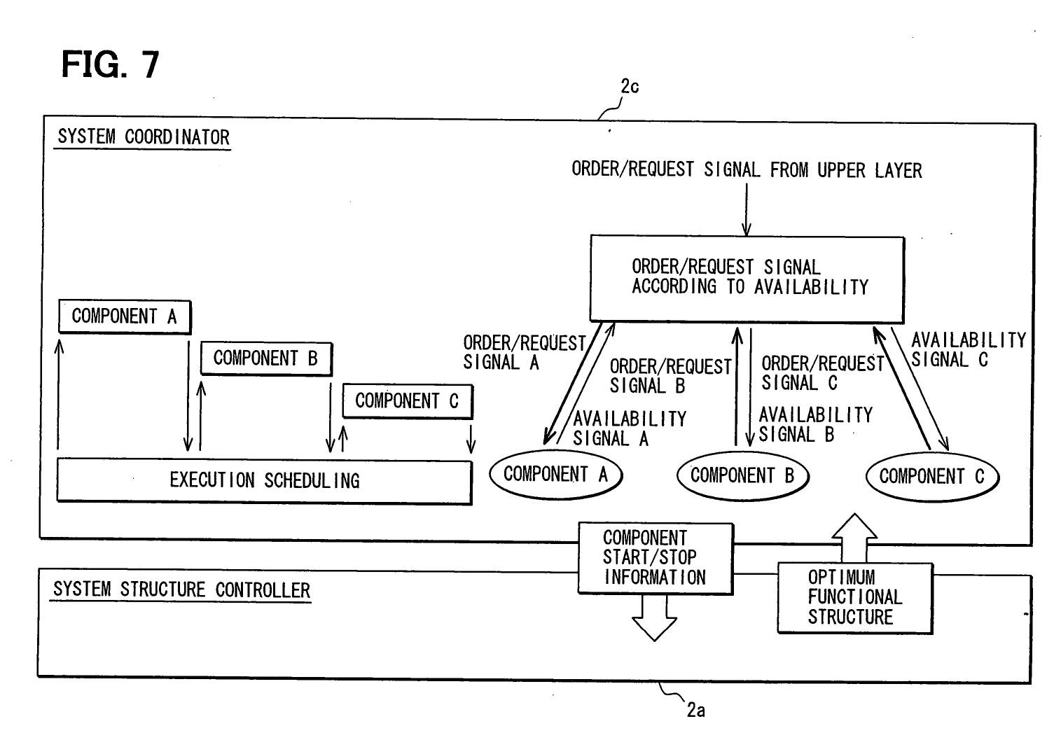

FIG. 7 shows a block diagram of functions in the system coordinator 5c. In this case, the optimum structure determined in the system structure controller 5a having components A to C is used to implement functions of each component. The order/request signal is sent to each component. The components A to C respond by sending back the availability signal to the system coordinator 5c. The system coordinator 5c recognizes the capability and the state of each component, and thereby sending a corresponding order/request signal to each of the components A to C.

The system coordinator 5c plays a critical role in dividing a required function into clearly-defined sub-functions, and defining relationship between those small functions. That is, the division of function facilitates the development of a large scale system by promoting the specialization and cooperation. The appropriately divided functions further ensures the quality of the developed system, and an improved efficiency of the development. The domains described above is one of the divided functional unit based on an abstraction of architecture of the vehicle network system.

For example, the vehicle coordinator 11 in FIG. 3 controls the layer of the vehicle domain 10, the vehicle motion coordinator 21 controls the layer of the vehicle motion domain 20, the power train coordinator 31 controls the layer of the power train domain 30, and the vehicle stability coordinator 41 controls the layer of the vehicle stability domain 40.

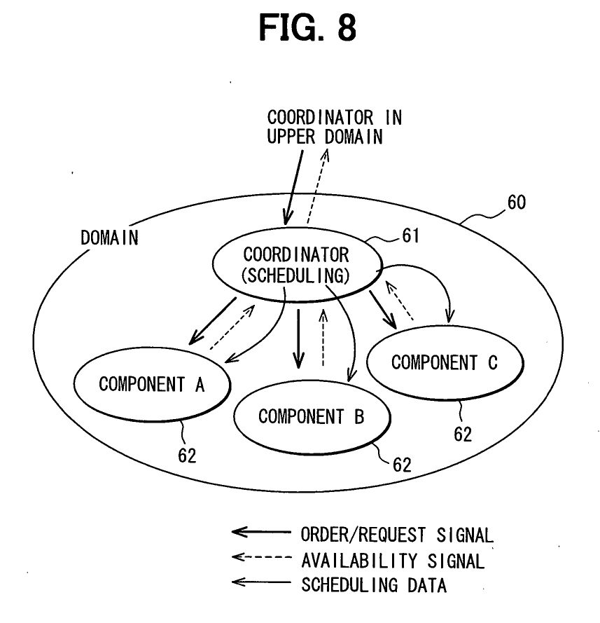

The system coordinator 5c implements a distributed processing architecture based on the system component of domains. That is, the functional architecture of those domains can be represented by an illustration in FIG. 8. In this case, the coordinator 61 controls the function distribution and execution scheduling of each of the components 62 in the domain 60. Therefore, the system coordinator 5c is a collective entity of the coordinator 61 and corresponding components in other domains.

The system coordinator 5c used in the above-described manner facilitates the ease of cooperation, collaboration and specialization by dividing the system into domains, and also ensures the quality assurance and improved efficiency of development.

The availability signal used by the system coordinator in controlling the function distribution is described in detail.

The availability signal is an interface for a downstream component, that is, an indicator used to inform the capability of functionality and state of functional component.

The capability of functionality is a feasible range of control instruction amount/control request amount. The state of functional component is an indicator that the downstream component is not functioning properly. That is, the availability signal is an indicator of the reliability of the downstream component. Therefore, the order/request signal is output according to the capability of functionality and the state of functional component represented by the availability signal, and the control instruction amount/control request amount are determined within the range of the capability of functionality and the state of functional component.

The capability of functionality is defined in two ways, that is, statically defined in design as a static maximum/minimum value of feasible order/request signal (e.g., a maximum/minimum engine torque), and dynamically defined as a dynamic capacity that can be realized in a certain amount of time from the present time (e.g., an engine torque range within 300 ms).

The state of functional component is defined as a state, for example, such as an initial state after starting a system, a normal state after initialization in waiting for an operation process, a temporary abnormal state, an extended/permanently broken state, a halt state of no functional processing, and the like.

The availability signal is calculated by the components themselves based on the availability signal of the downstream components and the sensor signal and the sensor quality information, and the calculated availability signal is sent to the coordinator in the domain. For example, a feasible engine torque range (i.e., an availability signal) and a state of the engine control component 37 can be calculated based on, for example, the amount of the fuel being controlled by the injection control, a state of an injector, the amount of the air being controlled by a throttle, a state of the throttle, an ignition timing being controlled by the ignition control, a state of the igniter, and the like. These conditions and state are available from the downstream component of the engine control component 37.

The component in a halt condition can be recognized by a coordinator in an upper layer based on a no-reporting condition of the component.

Further, the coordinator in the domain calculates and transfer the availability signal of the belonging domain because the domain is always regarded as a component in other domain in the upper layer.

For example, the power train coordinator 31 calculates the state and the axle torque range of the power train domain 30 based on the availability signal and the functional structure of the engine control component 37, the transmission control component 35 and the like, and the calculated range is transferred to the vehicle coordinator 11 as the availability signal of the power train component 30.

Further, the availability signal is used for tracking the trouble in the system. For example, a trouble in the vehicle network 1 may be recognized as multiple breakdowns in the system because of the cooperative operation of the multiple ECUs 2. Therefore, it is sometimes difficult to track down an actual trouble in the system. However, the availability signal having the capability and the state of each component can be used to track down the troubled portion of the system when the availability signal is analyzed.

The availability signal from each component can be used to track the system trouble when it is stored in an EEPROM or the like with time data. The availability signal can be stored efficiently in the storage by selectively picking up the signal that contains trouble data. In this manner, the availability signal at and around the time of trouble can efficiently be stored for trouble shooting.

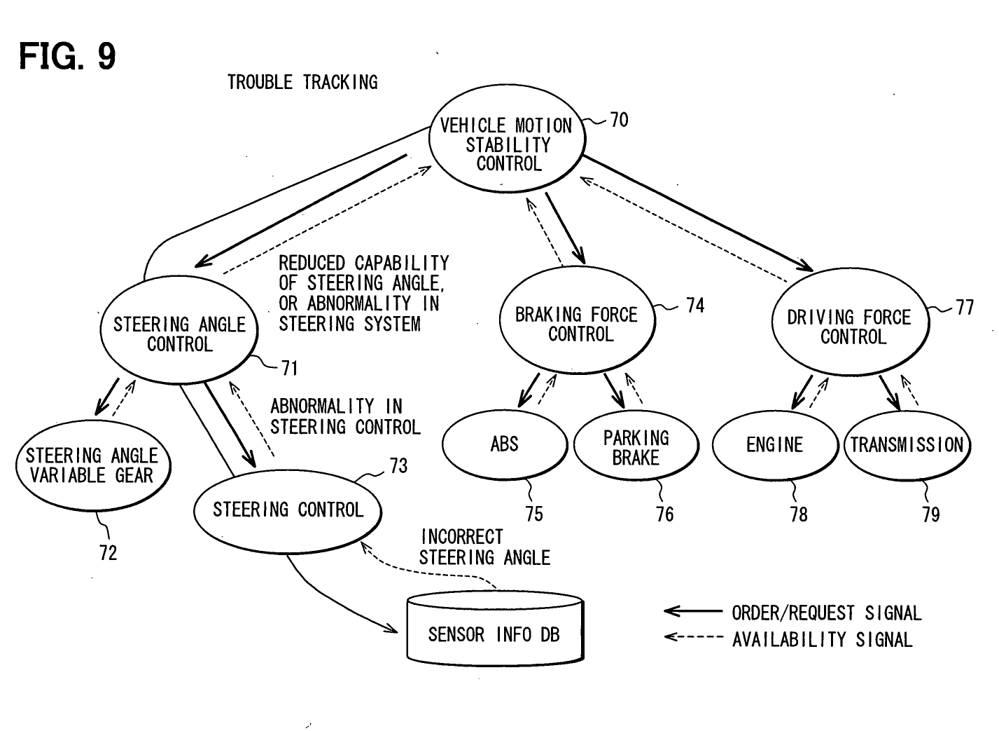

FIG. 9 shows a block diagram of trouble tracking in the vehicle network 1. An example of trouble tracking in the vehicle network 1 is described with reference to the drawing.

The domain 70 in FIG. 9 is, for example, used for vehicle motion stability control. The domain 70 includes a coordinator for vehicle motion stability control, and components for steering angle control, braking force control, and driving force control. The steering angle control component as a steering angle control domain 71 includes a steering angle control coordinator, a steering angle variable gear component 72 and a steering control compoenet 73. The braking force control component 74 includes, as a braking force control domain 74, a braking force control coordinator, an ABS control component 75 and a parking brake control component 76. Further, the driving force control component includes, as a driving force control domain, a driving force control coordinator, an engine control component 78 and a transmission control component 79.

In this scheme of components, the order/request signal is sent to a downstream component from a domain, and the availability signal is sent to the coordinator in an upstream component.

An abnormality of the steering because of a fault steering angle stored in a sensor information database in the virtual sensor 5b is used by the steering angle control coordinator in the steering angle control domain 71 to determine the capability of functionality and the state of functional component of the steering control. The steering angle control component transfers the availability signal having information on the reduced capability of the steering operation or an abnormality of the steering system to a vehicle motion stability control coordinator. In this manner, the vehicle motion stability control coordinator recognizes the trouble in the steering system.

Therefore, the availability signal sent to the vehicle motion stabilizing coordinator from the steering angle control component as well as the availability signal sent to the steering angle control coordinator from the steering control component 73 are checked for tracking the troubled portion in the system. An incorrect value used by the steering control component 73 is detected for determination of the troubled portion.

In this manner, the availability signal is tracked from the upper component toward the lower component for effectively identifying the troubled portion. Further, the availability signal used in a platform of a network system decreases the dependence of the diagnosis information on the vehicle type.

The troubled portion tracking is conducted by using a tester on the communication bus 3 in a dealer of the vehicle. For example, when the trouble data is included in a diagnosis signal in a frame on the communication bus 3, the troubled portion is displayed on a display of the tester 3 as soon as the tester is connected to the communication bus 3 for reading the diagnosis signal in the frame on the communication bus 3.

The availability signal used for function distribution by the system coordinator 5c. That is, the system coordinator 5c outputs the order/request signal based on the content of the availability signal. The function distribution has two types of implementation. The ACC (Adaptive Cruise Control) and the ESC (Electronic Stability Control) are one type that controls condition of driving and environment, and the other type is the fail-safe process that is intended for controlling system condition.

The former type of function distribution is implemented as an application of the system, and is realized as a logic in software components. The system coordinator 5c handles the latter type of function distribution, and the function distribution amount, that is, the order/request signal value is dependent on the condition of the system.

The system coordinator 5c calculates the order/request signal based on the arrangement of the function distribution determined by the coordinator in respective component. In this manner, the system coordinator 5c appropriately determines the function distribution suitable for the condition of the system.

More practically, the system coordinator 5c can manage a trouble handling process in the same manner as a normal operation process when a scheme for the functional distribution is built into the platform architecture. For example, the component having a trouble outputs the availability signal that indicates changes in the component. The system coordinator 5c recognizes the system condition by analyzing the availability signal, and determines the function distribution according to the analysis. In this manner, each component in the system is organized for implementing an intended functionality described in the order/request signal that reflects the function distribution even when the system coordinator 5c is handling a trouble in the system.

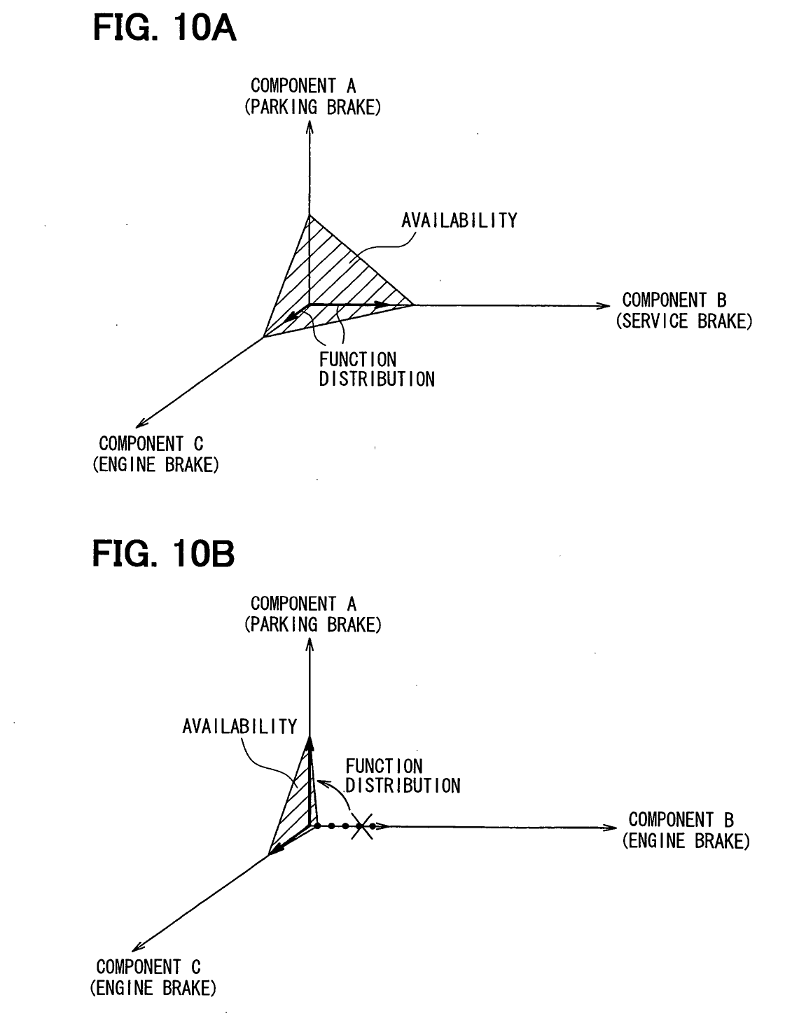

FIGS. 10A and 10B show illustrations of function distribution in various system status. The coordinator determines the request signal to components A to C. For example, the brake control coordinator determines the order/request signal to each of the components that control a parking brake, an engine brake and a service brake. The function distribution to each component (A to C) is determined based on the capability of functionality/state of functional component (i.e., availability signal) when the components A to C are working properly as shown in FIG. 10A. The function distribution among those components is changed according to the availability of the components when one of those components is not working as shown in FIG. 10B.

In this manner, the functional distribution among the components are dynamically controlled and changed to compensate a functional loss of certain component. Therefore, the intended functionality of the system is maintained without executing any specific process for trouble handling. That is, each of the components is simply operated according to the order/request signal output from the coordinator.

Next, scheduling of execution of the components by the system coordinator 5c is described. The system coordinator 5c conducts execution scheduling by using the unit of component in order to reflect the system administrator's point of view.

Conventionally, the vehicle control system is controlled by scheduling of software components within a boundary of each ECU (e.g., an injection time calculation process after starting a vehicle, a transmission control for current condition, etc.). However, an integrated vehicle control used in the present invention is provided through the cooperation of software components across the boundary of the ECU. This scheme of scheduling becomes very complicated when the schedule in each ECU has to be matched to each other for the cooperative execution.

Therefore, the unit of scheduling in the integrated vehicle control is designed as a combination of the components that represent vehicle functions having a granularity. In this manner, the system design is clearly understood in terms of a process flow and responses by the system designer, and thereby enabling a large scale development. The scheduling of the component described above is designated as “component scheduling” hereinafter.

More practically, the system coordinator 5c controls scheduling in each layer by using domain, and the coordinator as a subset of the system coordinator 5c in the each layer controls the scheduling of the components in the domain.

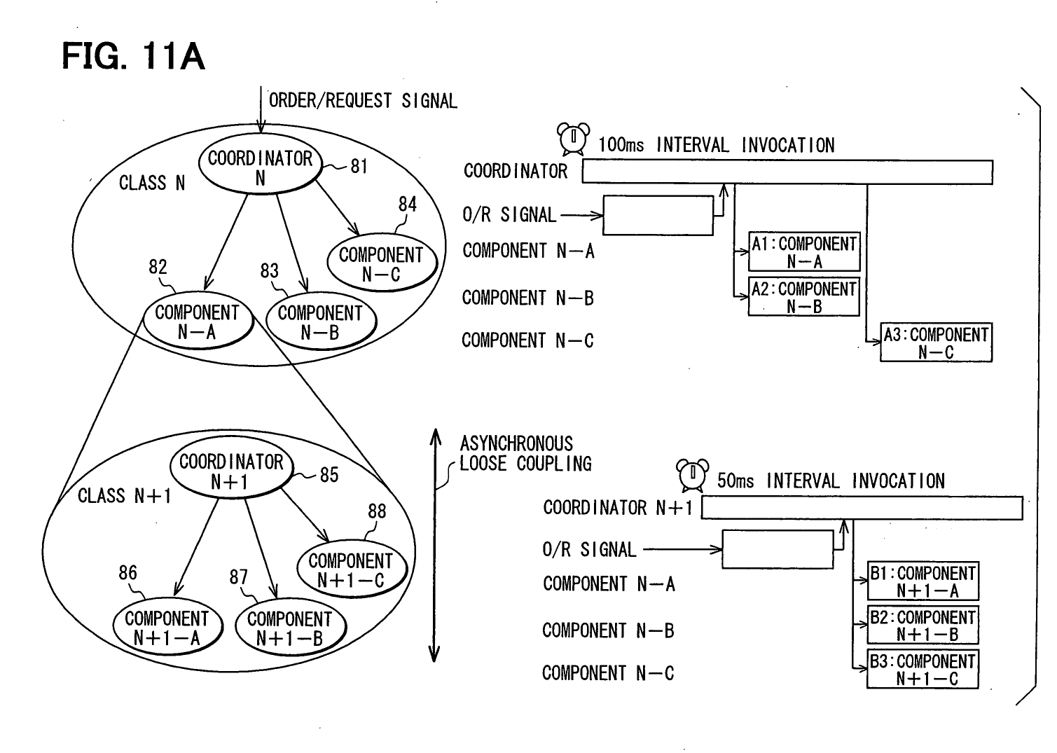

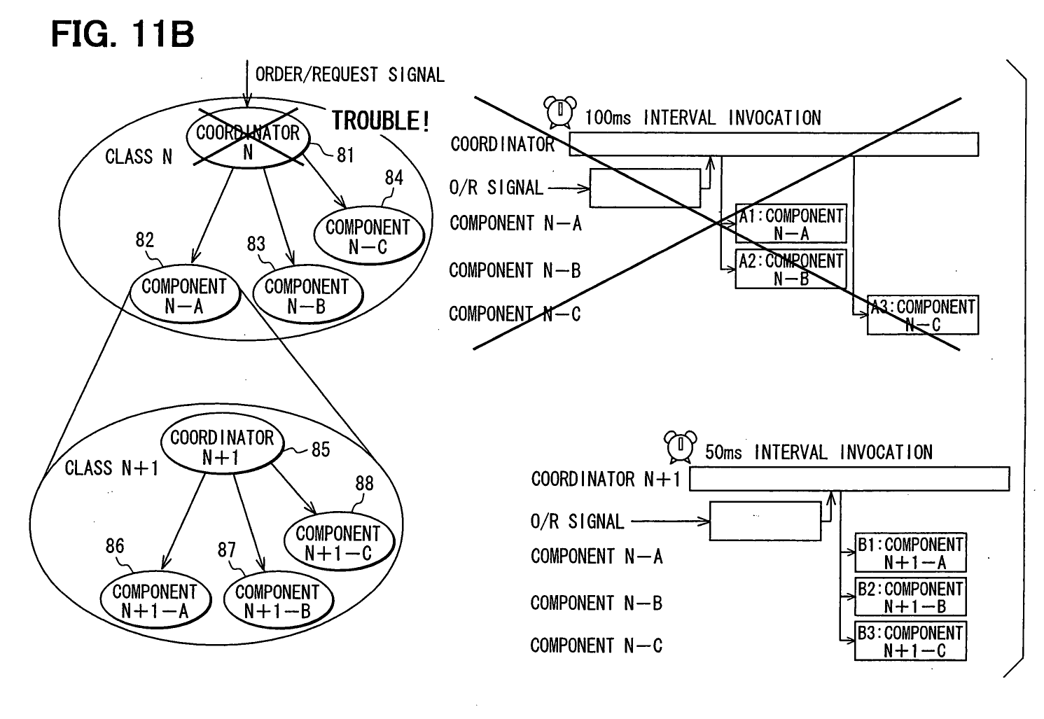

FIGS. 11A and 11B show illustrations of execution scheduling, that is, FIG. 11A is a normal execution scheduling, and FIG. 11B is a troubled execution scheduling.

In the domain in the layer N, the coordinator controls the components N−A, N−B, and N−C. In the domain in the layer N+1, the coordinator controls the components N+1−A, N+1−B, and N+1−C.

In this structure of components, the coordinator 81 of the domain in the layer N is invoked in, for example, an interval of every 100 ms. The coordinator 81 handles the order/request signal from the coordinator in the upper layer (N−1 layer), and controls scheduling A1 to A3 of the components 82 to 84 upon receiving the order/request signal in the interval.

The coordinator 85 of the domain in the layer N+1 is invoked in, for example, an interval of every 50 ms. The coordinator 85 handles the order/request signal from the coordinator 81 in the layer N, and controls scheduling B1 to B3 of the components 86 to 88 upon receiving the order/request signal in the interval.

When the coordinator 81 of the domain in the layer N is not working in trouble, execution of the components 82 to 84 can not be scheduled as shown in FIG. 11B. In this case, the coordinator 85 in the lower layer N+1 recognizes the trouble and takes over the role of the coordinator 81. That is, execution of the components 86 to 88 are scheduled by the coordinator 85 in the domain in the lower layer n+1. In this manner, a trouble in a portion of the system can be autonomously handled and the functionality of the system is maintained.

This autonomy can also be applied in the structure shown in FIG. 3. The vehicle domain 10 is managed under execution scheduling of the vehicle motion component 12 and the power train component 13 determined by the vehicle coordinator 11. The power train component 13 also works as a sub-domain, that is, the power train domain 30, and the power train coordinator 31 determines scheduling of the components 33 to 37 in the domain 30.

In this manner, the coordinator determines the schedule of the components in respective points of views of the domains. Scheduling across the domains is managed in the following manner. That is, the power train coordinator 31 manages execution scheduling of the components in the power train domain 30 so that a required axle torque indicated by the order/request signal is achieved in a given time allocated to the power train component 13 in the vehicle domain 10. In this manner, execution schedule in each domain is not necessarily be synchronous, or in other words, may be asynchronously scheduled.

The scheduling across the domains may be synchronized in order to decrease the response time. Synchronization between the domains means that the start of scheduling in the lower layer is in synchronization with the start of the assignment of the component in the upper layer.

The synchronization of the domains are achieved by the synchronization of the control interval between the domains in the upper and the lower layer as well as communication between the coordinators. That is, the start of the component in the domain of the upper layer has to be notified to the coordinator in the lower layer. The execution schedule in the lower layer starts at the same time as the notification to the coordinator. Therefore, the notification function that informs the coordinator of the start of the component is provided in the platform of the function distribution.

The coordinator in the lower layer is preferably designed to invoke autonomously in case of a trouble of the upper layer so that the coordinator in the upper layer does not affect or halt the entire system.

Further, the system coordinator 5c calculates the order/request signal according to the requested functional structure prepared by the system structure controller 5a besides outputting the availability signal. The system coordinator 5c also provides the information on the start/stop of each component to the system structure controller 5a for enabling the sleep and wake-up of the vehicle network 1.

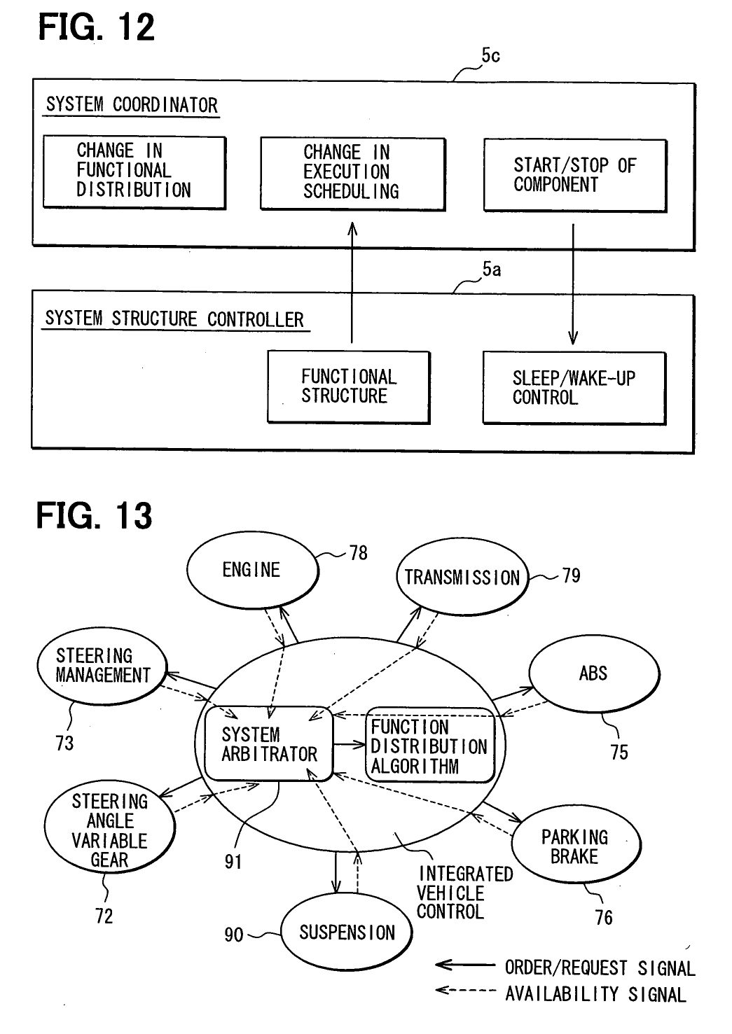

FIG. 12 shows a block diagram of a relationship between the system coordinator 5c and a system structure controller 5a. The function distribution and the execution schedule by the system coordinator 5c are described with reference to the drawings in FIG. 12.

The functional structure is determined by the system structure controller 5a as a combination of the components that is available (executable) depending on the operation condition of the ECU 2. The system structure controller 5a regards the component that is not included in the functional structure as not-executable, that is, not in a working condition of the intended function of the component.

In this manner, the system coordinator 5c precisely determines the capability and/or the state of the component based on the functional structure defined by the system structure controller 5a beside referring to the availability signal generated by the component itself.

The start and stop information on each component states that the state of functional component is either in an initial condition, a normal condition, an abnormal condition, or a trouble condition when the system is in start status, beside being in a stop status. The start status indicates that execution of the component is allowed, and the stop status indicates that execution of the component is stopped. The start and stop status are reciprocally changed by the system coordinator 5c.

The starustop information indicates that the component is in a start condition or in a stop condition. The system coordinator 5c manages the sleep and wake-up of the vehicle network 1 based on the start/stop information.

The system coordinator 5c changes the function distribution and the execution schedule based on the functional structure defined by the system structure controller 5a, and provides the start/stop information of the components to the system structure controller 5a for controlling sleep/wake-up of the network.

The hardware abstraction layer 6 is used for abstractive representation of the hardware system that includes the vehicle network 1 as well as the electronic characteristics of the ECU 2, the sensor 8, and the actuators and the like. That is, the networked hardware can be recognized as a virtual ECU as a whole by the upper layer of the system. Therefore, the hardware abstraction layer 6 provides a “transparent” data collection function for the ECU 2 as well as status management function and notification function of the hardware such as a power supply management, the ECU 2 mode management, the sleep/wake-up control of the vehicle network 1 and the like.

The hardware abstraction layer 6 has two primary layeres, that is, an ECU hardware abstraction layer 6a and communication abstraction layer 6b for representing the hardware and communication of the ECU, sensor, actuator and the like, as a lower layer, and a system abstraction layer 6c for representing the network system that includes the ECU 2 interconnected through the vehicle network 1 as an upper layer.

The ECU hardware abstraction layer 6a is used to convert the electrical signal from the sensors on the ECU to physical measurement data. For example, the sensor 8 (e.g., the wheel sensor 8a, the yaw rate sensor 8b, the acceleration sensor 8c, the steering angle sensor 8d and the like) connected to the ECU hardware abstraction layer 6a as shown in FIG. 2 outputs the sensor signal in analog format, and the ECU hardware abstraction layer 6a converts the data in the analog format into physical value.

The communication abstraction layer 6b is used to provide an interface of the signal to the upper layer by hiding the frame structure of the data or the like in a communication protocol.

The system abstraction layer 6c is used to provide a component communication service on behalf of the hardware network that includes the ECUs 2 interconnected through the network 1 as well as a bus control (sleep/wake-up) service, a network node detection service and a power supply information service for hardware trouble detection.

The system abstraction layer 6c handles the information from the communication abstraction layer 6b and the hardware abstraction layer 6a by using the same interface. That is, the system abstraction layer 6c informs the upper layer of the wheel speed without regard to the source of the information in response to the instruction from the upper layer of, for example, the system infrastructure layer 5 that vehicle speed information is required. In this case, the system abstraction layer 6c reports the vehicle speed information whatever the source is, that is, the source being the communication abstraction layer 6b, or the ECU hardware abstraction layer 6a that received detection signal from the wheel sensor. The identity of the source, that is, the information is derived from the communication abstraction layer 6b, or from the ECU hardware abstraction layer 6a, can be recognized by marking the information with an ID.

The system abstraction layer 6c informs the hardware state 6 of the vehicle network 1 and each of the ECUs 2 based on the information from the lower layers 6a and 6b.

The hardware abstraction layer 6 corresponds to the communication program and the software drivers disclosed in Japanese Patent Document JP-A-2002-204238. The description of these portions are omitted.

The ECU 2 described above includes the application layer 4, the system infrastructure layer 5 and the hardware abstraction layer 6 for the ease of the implementation of the control logic 7 in the functional framework 4a in the application layer 4. The rest of the portion other than the control logic 7 are commonly structured among the ECUs 2. In this manner, the role of each component in the ECU 2 is clearly defined, and thereby enabling and facilitating the cooperation and specialization.

This feature leads to the advantage of reduced development time, improved quality and reliability of the system, and the ease of variation handling for various vehicle models.

Further, the order/request signal, the availability signal, and the sensor signals are used throughout the ECU in the application layer 4 and the system infrastructure layer 5 by using the functional framework 4a.

That is, the control instruction amount/control request amount in the order/request signal and the capability of functionality/state of functional component in the availability signal are used in the framework of the control function development. The system status in measurement included in the sensor signal is calculated separately in the platform software from the control algorithm for proper use in the control function development.

The trouble in the vehicle network is tracked and identified by using the availability signal, and thereby enabling a provision of reliable ECU 2.

The functional structure in each ECU uses the coordinator for generating the order/request signal based on the availability signal and the observable quantity stored in the virtual sensor 5b. In this manner, the function distribution is appropriately provided to the lower layer component. That is, the troubled component can be covered by the working component in terms of the function distribution.

The availability signal determines and includes the control instruction amount and the control request amount within the range of the capability of functionality and the state of functional component in the order/request signal. Therefore, the control instruction amount/control request amount not within the range of the capability of functionality/state of functional component indicate that the system in a trouble. In this case, the component 62 receiving the erroneous signal may determine that the system is in a trouble, and may inform the system that the signal from the coordinator 61 is not usable, or may use a system arbitrator for handling the trouble.

For example, as shown in FIG. 13, a system arbitrator 91 may be provided for determining an optimum control request amount based on the availability signal from the components 72, 73, 75, 76, 78, and 90. In this manner, the system structure is optimally organized for trouble handling as well as normal operation handling.

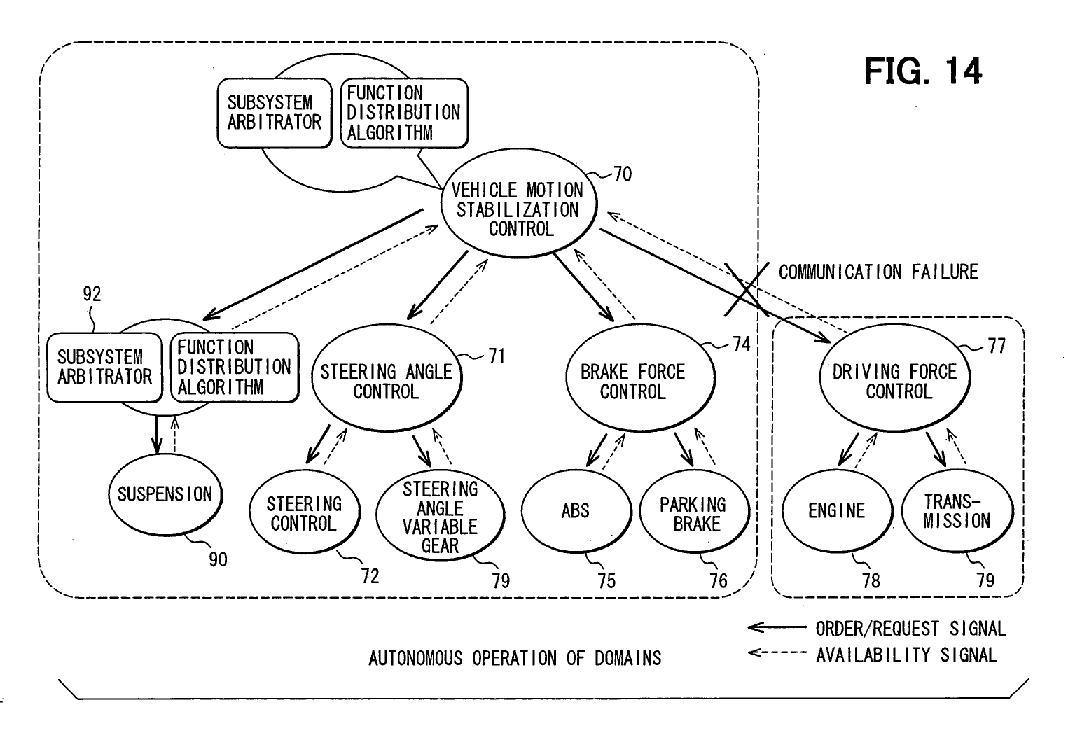

Further, the system arbitrator 91 may be provided in each functional layer instead of providing only one for the entire vehicle network 1. For example, as shown in FIG. 14, a subsystem arbitrator 92 may be provided for handling the trouble in the vehicle motion stability domain. In this manner, the troubled component is separated in the domain and the function of the system is maintained by using the remaining components.

Although the present invention has been fully described in connection with the preferred embodiment thereof with reference to the accompanying drawings, it is to be noted that various changes and modifications will become apparent to those skilled in the art.

For example, the system status in measurement may be calculated by using a specific logic in a predetermined ECU 2, or may be calculated in all ECUs 2 after sending the required information through the communication bus 3 to the all ECUs 2. The observable quantity may also be calculated after calculating an interim calculation value. This interim value may also be calculated in a specific ECU 2 or in all ECUs 2.

The ECUs 2 in the above-described embodiment is structured in three layers. However, the number of the layers may be more than three, or may be less than three, that is, may be two layers or less when two of the three layers are integrated.

Such changes and modifications are to be understood as being within the scope of the present invention as defined by the appended claims.

What is claimed is:

1. A vehicle network system having a plurality of electronic control units for providing control functionality components by exchanging data through a communication bus that connects each of the plurality of the electronic control units, the control functionality components of the electronic control unit comprising:
a functional framework for providing a control logic that is given by external definition;
a system coordinator for issuing a control request base on a capability and a state of control functionality as well as determining an execution schedule of the control functionality;
a system structure controller for dynamically maintaining and reorganizing control functionality of the electronic control unit based on the definition of the control functionality;
a virtual sensor for detecting and outputting observable quantity as a sensor signal; and
a hardware abstraction portion for abstractively representing an entire hardware system of the vehicle network including the electronic control unit as a virtual electronic control unit for the system structure controller and the virtual sensor.

2. The vehicle network system according to claim 1 further comprising:
an application layer having the functional framework;
a system infrastructure layer having the system structure controller, the virtual sensor and the system coordinator; and
a hardware abstraction layer having the hardware abstraction portion.

3. The vehicle network system according to claim 2 further comprising:
a coordinator for outputting an order/request signal; and
a functional component for implementing a predetermined function and outputting an availability signal that is an indicator for a state of functional component and a capability of functionality as well as an availability of the predetermined function,
wherein the functional framework has a hierarchical control functionality,
the coordinator outputs the order/request signal based on the availability signal and the sensor signal from the virtual sensor, and
the functional component outputs the availability signal based on the sensor signal from the virtual sensor.

4. The vehicle network system according to claim 3,
wherein the hardware abstraction portion informs the system structure controller of the state of the hardware system including a plurality of the electronic control units, and
the system structure controller appropriately reorganizes the control functionality based on the hardware status amount.

5. The vehicle network system according to claim 4,
wherein the virtual sensor handles and controls physical value derived from an actual sensor included in the hardware system and the observable quantity that is abstracted from the physical value as system data.

6. The vehicle network system according to claim 5,
wherein the system coordinator implements the predetermined function in each layer of the hierarchical control functionality as the coordinator for outputting the order/request signal and the execution schedule and the functional component for implementing the predetermined function and outputting the availability signal that is the indicator for the state of functional component and the capability of functionality as well as the availability of the predetermined function,
the coordinator outputs the order/request signal and the execution schedule based on the availability signal and the sensor signal from the virtual sensor, and
the functional component outputs the availability signal based on the sensor signal from the virtual sensor and implements the predetermined function based on the execution schedule.

7. The vehicle network system according to claim 6,
wherein a trouble in the hardware system is recorded in the availability signal as trouble data.

8. The vehicle network system according to claim 7,
wherein a tester on the communication bus is used to indicate a troubled component based on the availability signal that includes the trouble data.

9. The vehicle network system according to claim 7,
wherein the system coordinator organizes the coordinators to autonomously compensate a function of any of the coordinators in a layer by using other coordinator for outputting the execution schedule of the functional components in the same layer.

10. An electronic control unit in a vehicle network system comprising:
a functional framework for providing a control logic that is given by external definition;
a system coordinator for issuing a control request base on a capability and a state of control functionality as well as determining an execution schedule of the control functionality;
a system structure controller for dynamically maintaining and reorganizing control functionality of the electronic control unit based on the definition of the control functionality;
a virtual sensor for detecting and outputting observable quantity as a sensor signal; and
a hardware abstraction portion for abstractively representing an entire hardware system as a virtual electronic control unit for the system structure controller and the virtual sensor.
